(19) United States
(12) Patent Application Publication
(10) Pub. No.: US 2025/0352969 A1
(43) Pub. Date: Nov. 20, 2025

(54) PREPARATION METHOD FOR POLYURETHANE MICROCAPSULE SHELL WITH CONTROLLED-RELEASE CHARACTERISTIC INFLUENCED BY MECHANICAL STIMULUS

(71) Applicant: Guizhou Power Grid Co., Ltd., Guiyang (CN)

(72) Inventors: Ying ZHANG, Guiyang (CN); Mingwei WANG, Guiyang (CN); Zhe LIU, Guiyang (CN); Pengcheng YU, Guiyang (CN)

(21) Appl. No.: 19/280,202

(22) Filed: Jul. 25, 2025

Related U.S. Application Data
(63) Continuation of application No. PCT/CN2024/105495, filed on Jul. 15, 2024.

(30) Foreign Application Priority Data
Jan. 19, 2024 (CN) 202410080799.3

(51) Int. Cl. B01J 13/12; B01J 13/08

(52) U.S. Cl. CPC B01J 13/12; B01J 13/08

(57) ABSTRACT

Disclosed is a preparation method for a polyurethane microcapsule shell with a controlled-release characteristic influenced by a mechanical stimulus. The preparation method includes: mixing deionized water and polyvinyl alcohol to obtain an aqueous phase A; adding oil phase 4, 4′-methylenediphenyl diisocyanate into the aqueous phase A to obtain an emulsion; mixing deionized water with dibutyltin dilaurate and ethylene glycol to obtain an aqueous phase B; dropping the emulsion into the aqueous phase B, and performing stirring at a constant temperature to obtain a mixed solution; and performing vacuum filtration on the mixed solution after the mixed solution is cooled to a room temperature, washing the mixed solution with ethanol, then drying the mixed solution in air at a room temperature after vacuum filtration, and obtaining the polyurethane microcapsule shell. The present disclosure has a controlled-release characteristic that a release speed can be regulated when subjected to an external mechanical stimulus.

### CROSS-REFERENCE TO RELATED APPLICATIONS

This application is a continuation of International Application No. PCT/CN2024/105495, filed on Jul. 15, 2024, and claims priority to Chinese Patent Application No. 202410080799.3, filed on Jan. 19, 2024, the entire disclosure of which is incorporated herein by reference.

### TECHNICAL FIELD

The present disclosure belongs to the technical field of material science and engineering, and particularly relates to a reparation method for a polyurethane microcapsule shell with a controlled-release characteristic influenced by a mechanical stimulus.

### BACKGROUND

Microencapsulation is a surface modification technology that utilizes film-forming materials to encapsulate internal core materials, thereby forming stable core-shell structures. Due to the advantages such as convenience, flexibility, uniform dispersion, ease of storage and transportation of encapsulated substances, and stabilized activity, the microencapsulation has gradually become a superior material encapsulation approach. In self-healing materials, the microcapsules, serving as carriers for storing and releasing healing agents, can provide a precise core-material release and protection mechanism for materials. This enables self-healing of the materials, effectively prolongs service life of substrates, and reduces cost associated with online monitoring and fault maintenance of an apparatus. The formation of microcapsule shells constitutes the core and critical step in the microencapsulation. The microcapsule shells not only determine the stability, protective properties and release characteristics of the microcapsules, but also directly affect the effectiveness of the microcapsules in different applications fields.

The main chemical preparation methods for the microcapsule shells in common use include in-situ polymerization and interfacial polymerization. The in-situ polymerization refers to a method in which monomer or precursor polymerization reaction is carried out directly inside the microcapsules to form the microcapsule shells. The preparation of the microcapsule shells via the in-situ polymerization features mild reaction conditions, relatively simple methods, high reaction efficiency, and easy control of the molecular weight and distribution of polymers. However, walls of the microcapsules formed through this method are hard, and the compatibility and stability of original materials need to be considered in some preparation steps, leading to a limited choice of materials. The interfacial polymerization is a method that uses polymers at the interface of two immiscible liquids to react by polymerization to form the microcapsule shells. By using the interfacial polymerization to prepare the microcapsules, the size and morphology can be more accurately controlled. The formed walls of the microcapsules are softer. A variety of different materials can be flexibly used for the interfacial polymerization to meet different application requirements. The interfacial polymerization is usually used to prepare shells of polyamines, polyureas, polythioureas, polyesters, and so on. Their preparation may produce volatile organic compounds or involve the emission of toxic gases, which can easily pollute the environment. So the preparation has strict process requirements and high production costs. To reduce the impact on the environment while optimizing the performance of the microcapsules, a number of preparation methods for the polyurethane microcapsule shells exist.

Existing prepared polyurethane microcapsule shells generally have favorable flexibility and abrasion resistance, and can effectively protect their internal core materials against the external environment. However, the controlled-release characteristic is slow, and the duration is long, so the polyurethane microcapsule shells are mostly used in the field of spices, food additives, etc. to prolong the duration of the effect of substances and improve the utilization rate. However, the slow controlled-release characteristic is not suitable for the rapid inhibition and repair in the primary damage development stage of minor damage to insulating materials in the field of electrical engineering. Improvements in the performance of the polyurethane microcapsule shells are necessary for the timely response of the microcapsules to self-healing of damage to electric apparatuses.

### SUMMARY

An objective of the present part is to provide an overview of some aspects of examples of the present disclosure and a brief description of some preferred examples. Simplifications or omissions may be made in the present part as well as the abstract of the description and the title of invention of the present disclosure, so as not to obscure the objective of the present part as well as the abstract of the description and the title of invention. However, such simplifications or omissions cannot be used to limit the scope of the present disclosure.

In view of the above and/or problems in the prior art, the present disclosure is provided.

Consequently, an objective of the present disclosure is to provide a preparation method for a polyurethane microcapsule shell with a controlled-release characteristic influenced by a mechanical stimulus in order to overcome deficiencies in the prior art.

In order to solve the above technical problems, the present disclosure provides a preparation method for a polyurethane microcapsule shell with a controlled-release characteristic influenced by a mechanical stimulus. The preparation method includes:

mixing deionized water and polyvinyl alcohol to obtain an aqueous phase A;

adding oil phase 4, 4′-methylenediphenyl diisocyanate into the aqueous phase A to obtain an emulsion;

mixing deionized water with dibutyltin dilaurate and ethylene glycol to obtain an aqueous phase B;

dropping the emulsion into the aqueous phase B, and performing stirring at a constant temperature to obtain a mixed solution; and

performing vacuum filtration on the mixed solution after the mixed solution is cooled to a room temperature, washing the mixed solution with ethanol, then drying the mixed solution in air at a room temperature after vacuum filtration, and obtaining the polyurethane microcapsule shell.

As a preferred solution of the preparation method of the present disclosure, the deionized water and the polyvinyl alcohol are mixed to obtain the aqueous phase A, and a mass ratio of the deionized water to the polyvinyl alcohol is 100 ml-150 ml:1 g-3 g.

As a preferred solution of the preparation method of the present disclosure, the deionized water and the polyvinyl alcohol are mixed to obtain the aqueous phase A, and a mixing temperature is 30 DEG C to 50 DEG C.

As a preferred solution of the preparation method of the present disclosure, the oil phase 4, 4′-methylenediphenyl diisocyanate is added into the aqueous phase A to obtain the emulsion, and a volume ratio of the aqueous phase A to the oil phase 4, 4′-methylenediphenyl diisocyanate is 15-18:1.

As a preferred solution of the preparation method of the present disclosure, the deionized water is mixed with the dibutyltin dilaurate and the ethylene glycol to obtain the aqueous phase B, and a volume ratio of the deionized water to the dibutyltin dilaurate to the ethylene glycol is 40-60:0.4-0.6:1.5-2.

As a preferred solution of the preparation method of the present disclosure, a molar ratio of the ethylene glycol to the 4, 4′-methylenediphenyl diisocyanate is 1:1.

As a preferred solution of the preparation method of the present disclosure, the emulsion is dropped into the aqueous phase B, stirring is performed at the constant temperature to obtain the mixed solution, and the constant temperature is 60 DEG C to 80 DEG C.

As a preferred solution of the preparation method of the present disclosure, duration of the stirring is 1.5 h to 2 h.

As a preferred solution of the preparation method of the present disclosure, the mixed solution is washed with the ethanol, and a mass fraction of the ethanol is 30%.

As a preferred solution of the preparation method of the present disclosure, a number of washing times is 2 to 3.

The present disclosure has the beneficial effects as follows:

(1) The present disclosure optimizes a synthesis method for microcapsules with polyurethane-based shells, reveals a structure-performance relationship of a shell structure on a controlled-release issue, and provides a preparation method for a polyurethane microcapsule shell with a controlled-release characteristic influenced by a mechanical stimulus, so as to effectively inhibit a primary development stage of minor damage of an electric apparatus.

(2) In the present disclosure, a polyurethane microcapsule shell with a controlled-release characteristic influenced by a mechanical stimulus is prepared through interfacial polymerization. A molecular weight of diol used in a preparation process directly influences mechanical properties of a microcapsule and release time of a coated core material. The higher the molecular weight of the diol used is, the higher the mechanical strength of the formed microcapsule is, and the longer the release time of the internal core material is.

(3) The present disclosure uses interfacial polymerization to prepare a polyurethane microcapsule shell sample with a controlled-release characteristic influenced by a mechanical stimulus. A basic principle is that 4, 4′-methylenediphenyl diisocyanate (DPMDI) prepolymers are dispersed in an aqueous phase and then formed into an emulsion in water by an emulsifier. The prepolymer emulsion is slowly dropped into an aqueous phase containing a crosslinking agent under stirring action. Crosslinking polymerization reaction occurs under the action of the crosslinking agent, and a polyurethane microcapsule shell structure is formed.

### BRIEF DESCRIPTION OF DRAWINGS

In order to describe the technical solutions in the examples of the present disclosure more clearly, a brief description of the accompanying drawings required for describing the examples will be provided below. Obviously, the accompanying drawings in the following description show merely some examples of the present disclosure. Those of ordinary skill in the art can also derive other accompanying drawings from these accompanying drawings without making creative efforts. In the figures:

FIG. 1 is a schematic diagram of a reaction process of forming a polyurethane microcapsule shell according to the present disclosure;

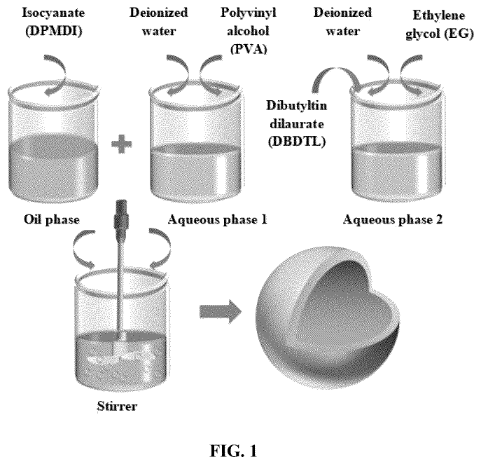

FIG. 2 is a scanning electron microscope (SEM) image of an undamaged polyurethane microcapsule shell of Example 1 according to the present disclosure;

FIG. 3 is a particle size distribution diagram of Example 1 according to the present disclosure;

FIG. 4 is a Fourier transform infrared (FT-IR) diagram of a polyurethane microcapsule shell of Example 1 according to the present disclosure;

FIG. 5 is a curve graph showing a weight percentage change of microcapsules according to the present invention in 30 days; and

FIG. 6 is a curve graph showing a release rate of an essential oil atmosphere in microcapsules according to the present disclosure.

### DETAILED DESCRIPTION OF THE EMBODIMENTS

In order to make the above objectives, features, and advantages of the present disclosure clearer and more understandable, the particular embodiments of the present disclosure will be described in detail below in conjunction with the examples of the description.

In the following description, numerous concrete details are set forth in order to provide a thorough understanding of the present disclosure. However, the present disclosure may be implemented otherwise than as specifically described herein. Those skilled in the art can make similar developments without departing from the spirit of the present disclosure, and therefore the present disclosure is not to be limited by the specific examples disclosed below.

Secondly, reference herein to “an example” or “example” means a specific feature, structure, or characteristic that can be included in at least one embodiment of the present disclosure. The phase “in an example” at different places in the present description neither refers to the same example, nor is a separate or selective example mutually exclusive of other examples.

Manufacturers and purity of chemical reagents used in preparing polyurethane microcapsule shell samples in the method of the present disclosure are shown in Table 1:

TABLE 1

| Reagent name | Purity | Manufacturer |
|---|---|---|
| 4,4′-methylenediphenyl | 98% | Aladdin Biochemical |
| diisocyanate (DPMDI) | | Technology Co., Ltd. |
| Ethylene glycol (EG) | AR, 98% | Aladdin Biochemical |
| | | Technology Co., Ltd. |
| Polyvinyl alcohol Mowiol ® | 96.8-97.6 | Aladdin Biochemical |
| PVA-103 | mol % | Technology Co., Ltd. |
| Ethanol | GR, 95% | Aladdin Biochemical |
| | | Technology Co., Ltd. |
| Dibutyltin dilaurate | 95% | Macklin reagent |
| (DBDTL) | | |
| Deionized water | — | Macklin reagent |

Models and manufacturers of main experimental instruments for preparing polyurethane microcapsule shell samples in the method of the present disclosure are shown in Table 2:

TABLE 2

| Apparatus name | Model | Manufacturer |
|---|---|---|
| Thermostatic magnetic | Joinlab | JOAN LAB EQUIPMENT |
| stirrer | | CO., LTD |
| Computer numerical control | OS40-S | Beijing DRAGONLAB |
| mechanical mixer | | |
| Numerically controlled | HH-2S | Enyi |
| thermostatic water bath | | |
| Vacuum oven | YZWZ-1 | Nanjing Yanzheng |
| Electronic scale | TD60001C | Tianma Hengji |
| | | Instruments Co., Ltd. |

### Example 1

A preparation method for a polyurethane microcapsule shell with a controlled-release characteristic influenced by a mechanical stimulus provided in the present disclosure includes:

### (1) An Aqueous Phase A was Prepared

130 ml of deionized water and 2.2 g of polyvinyl alcohol (Mowiol® PVA-103) were added to a 250-mL beaker. A temperature of a computer numerical control magnetic stirrer was set at 40 DEG C, and a rotation speed was set at 400 r/min. Magnetic stirring was performed for mixing thoroughly.

### (2) An Oil Phase was Added to the Aqueous Phase A

7.5 mL of 4, 4′-methylenediphenyl diisocyanate (DPMDI, as an oil phase) was added to the aqueous phase A. A mechanical stirrer was set at 3500 r/min for stirring for 10 min. A mixed solution was poured into a glass reactor to obtain an emulsion.

### (3) An Aqueous Phase B was Prepared

60 mL of deionized water, 0.6 mL of dibutyltin dilaurate (DBDTL) and 1.8 mL of ethylene glycol (EG, equimolar mass with DPMDI) were added to a 100-mL beaker.

### (4) The Emulsion was Added to the Aqueous Phase B

The emulsion in the glass reactor in (2) was slowly dropped into the aqueous phase B, and then put into a thermostatic water bath. A temperature was raised to 70 DEG C. The mechanical stirrer was set at 200 r/min for stirring for 2 h.

### (5) Washing and Drying Were Performed

After cooling to a room temperature, the mixed solution was subjected to vacuum filtration, and was washed with 30% ethanol for 3 times, and dried in air at a room temperature for 24 h after vacuum filtration.

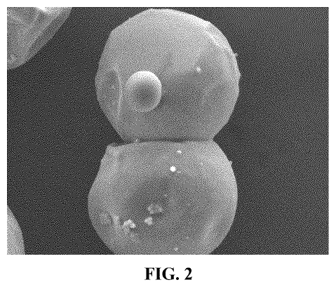

Dried polyurethane microcapsule shell samples were put on a sample table, sprayed with platinum for sample preparation, then tested and observed by a scanning electron microscope (SEM). An SEM image is shown in FIG. 2. It can be seen from the figure that microcapsules present full spherical shapes, uniform particle sizes, and complete shapes without damage, reflecting desirable mechanical properties of the polyurethane microcapsule shells. In terms of dispersibility, core-shell structures of the prepared microcapsules are mostly individuals without obvious adhesion. This proves that the dispersibility is desirable. A shell thickness of a damaged microcapsule shell is about 6.73 μm by a scanning electron microscope. An outer surface of the core shell is not completely smooth, but has many fine protrusions, which may be caused by incomplete reaction of prepolymers. The rough outer surface can enhance interaction between a substrate and the microcapsules when a composite material is prepared, making them mesh more closely.

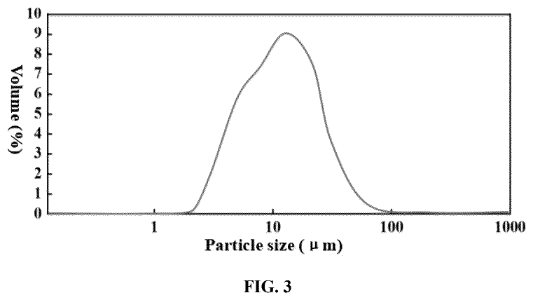

An image of particle size distribution of Example 1 is calibrated to a standard size by an optical microscope observation system. Then the sample is measured by sampling software. A particle size distribution curve is plotted by Origin plotting software as shown in FIG. 3. It can be seen from the figure that the particle size distribution of the prepared samples is concentrated in 10 μm to 30 μm, and the particle size distribution is uniform. Single-mode distribution is successfully achieved in a narrow particle size range. This is conducive to the practical application of the shells in insulating composite materials.

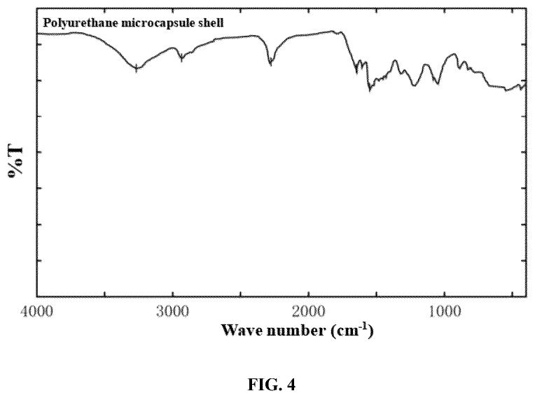

A Fourier transform infrared (FT-IR) spectrum obtained by measuring Example 1 is shown in FIG. 4, from which some major peak assignments (—CH, etc.) can be seen. Compared with FT-IR spectra of other compounds, whether the polyurethane microcapsules are successfully prepared can be determined.

### Example 2

In order to study a controlled-release characteristic, influenced by a mechanical stimulus, of a polyurethane microcapsule shell, some self-healing core materials may be added into the shell before forming. By comparing FT-IR images and weight change percent curves of a microcapsule with the self-healing core materials before and after release, a change of the controlled-release characteristic of the microcapsule shell influenced by the mechanical stimulus can be obtained.

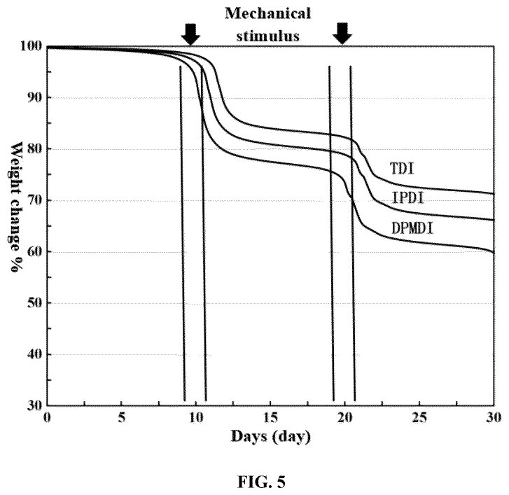

As can be seen from FIG. 5, when no external mechanical stimulus (scratch, etc.) is applied, the weight percentage of the microcapsule shell remains basically unchanged due to its stability. When the microcapsule is mechanically stimulated once every 10 days, the internal self-healing core materials are released rapidly due to timely rupture of the polyurethane microcapsule shell in a second day of the stimulus. The core materials are cured in short time to implement self-healing of the material. The FT-IR image of the microcapsule after release is similar to an FT-IR image of the polyurethane microcapsule shell, thus this proves that the internal core materials are released successfully.

### Comparative Example 1

A difference from Example 1 is that the oil phase in step (2) is toluene-2, 4-diisocyanate (TDI).

### Comparative Example 2

A difference from Example 1 is that the oil phase in step (2) is isophorone diisocyanate (IPDI).

In Table 3, encapsulation efficiency of microcapsule shells prepared in Example 1 and Comparative Examples 1 and 2 is determined as follows:

TABLE 3

| Isocyanate | Encapsulation | |
|---|---|---|
| (mL) | efficiency | |
| DPMDI | 48.7% | Example 1 |
| TDI | 34.9% | Comparative |
| | | Example 1 |
| IPDI | 39.84% | Comparative |
| | | Example 2 |

As shown in FIG. 5, interaction between DPMDI and EG (Example 1) results in higher core material encapsulation and release efficiency than interaction between other two diisocyanates and EG (Comparative Examples 1 to 2).

### Comparative Example 3

A difference from Example 1 is that no ethylene glycol is added in step (3).

### Comparative Example 4

A difference from Example 1 is that a molar ratio of the ethylene glycol to the 4, 4′-methylenediphenyl diisocyanate in step (3) is 1:2.

### Comparative Example 5

A difference from Example 1 is that a molar ratio of the ethylene glycol to the 4, 4′-methylenediphenyl diisocyanate in step (3) is 2:1.

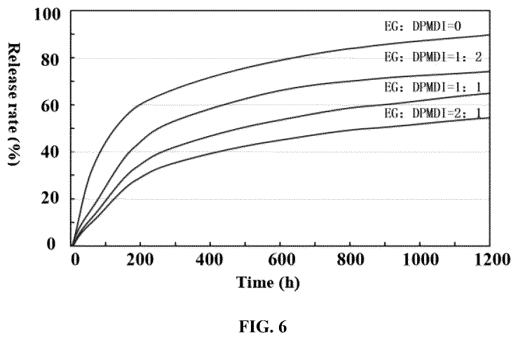

In order to compare influences of different molecular weights of the ethylene glycol on the controlled-release characteristic, a certain amount of essential oil is added into microcapsules for encapsulation before shell formation. Shell thicknesses of encapsulation are shown in Table 4 below. Release rate curves of essential oil atmospheres in the formed microcapsules are shown in FIG. 6. A release rate of a microcapsule with a thinnest shell is the fastest. A selected experimental molar ratio of 1:1 can achieve a particular shell thickness and also guarantee particular encapsulation efficiency. The present disclosure has innovative points that a film thickness is determined by the molecular weight of the ethylene glycol, thus the release characteristic is influenced. A limit value of a molar mass ratio is 1:1 without influencing the encapsulation efficiency. In practical application, microcapsules with a release rate varying with the film thickness can be prepared according to actual requirements. More than 1 may influence the use of the core materials. The ethylene glycol influences the controlled-release characteristic of the polyurethane microcapsule shells through a mechanism that a molecular weight of diol directly influences mechanical properties of the microcapsules and release time of coated core materials. The higher the molecular weight of the diol used is, the tighter a network structure formed by crosslinking reaction is, and moreover, the stronger an attraction force and a bonding force between molecules are. Thus, a more uniform and thick wall layer is formed. Then stability and mechanical strength of the formed microcapsules are higher. The release time of the internal core materials is longer. Leakage of the core materials is effectively prevented.

TABLE 4

| | Shell thickness/μm | |
|---|---|---|
| EG:DPMDI = 0 | 5.03 | Comparative Example 3 |
| EG:DPMDI = 1:1 | 6.73 | Example 1 |
| EG:DPMDI = 1:2 | 5.87 | Comparative Example 4 |
| EG:DPMDI = 2:1 | 7.61 | Comparative Example 5 |

The higher the shell thickness is, the higher the mechanical strength and stability are, but at the same time the lower the internal encapsulation efficiency is. Accordingly, the shell thickness is not necessarily better when thicker. The encapsulation efficiency of the internal core materials needs to be considered.

### Comparative Example 6

In CN 107903877 A, (1) n-octadecane and TDI were dissolved in a cyclohexane solvent to prepare an evenly mixed oil phase system; (2) an emulsifier and OP-10 were added into a beaker filled with distilled water, and stirring was performed to prepare an evenly mixed aqueous phase system; (3) the oil phase was poured into the aqueous phase beaker, and stirring was performed by a homogenizer, to form

a uniform O/W emulsion; (4) the emulsion was transferred into a three-necked flask, and a rotation speed was reduced; (5) diethylenetriamine (DETA) and distilled water were uniformly mixed, dropped into the emulsion at a constant speed, and slowly heated to 60 DEG C after dropping, and reacted at the temperature for 3 hours, to obtain a microcapsule suspension; and (6) an obtained product was subjected to vacuum filtration, washed with distilled water and ethanol, and subjected to vacuum filtration, and finally an obtained filter cake was dried in a vacuum oven, to obtain n-octadecane/polyurea resin phase change microcapsules.

The oil phase system in Comparative Example 6 is a solvent mixture of n-octadecane, TDI and cyclohexane, while the oil phase in the present disclosure is 4, 4′-methylenediphenyl diisocyanate, and the ethylene glycol is added to influence the controlled-release characteristic. The mechanism is that a molecular weight of diol directly influences mechanical properties of the microcapsules and release time of coated core materials. The higher the molecular weight of the diol used is, the higher mechanical strength of the formed microcapsules is, and the longer the release time of the internal core materials is. As shown in Table 1 and FIG. 5, interaction between DPMDI and EG (Example 1) results in higher core material encapsulation and release efficiency than interaction between other two diisocyanates and EG (Comparative Examples 1 to 2).

It should be noted that the above examples are merely used to explain the technical solutions of the present disclosure and are not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the present disclosure.

What is claimed is:

1. A preparation method for a polyurethane microcapsule shell with a controlled-release characteristic influenced by a mechanical stimulus, comprising:
mixing deionized water and polyvinyl alcohol to obtain an aqueous phase A;
adding oil phase 4, 4′-methylenediphenyl diisocyanate into the aqueous phase A to obtain an emulsion;
mixing deionized water with dibutyltin dilaurate and ethylene glycol to obtain an aqueous phase B;
dropping the emulsion into the aqueous phase B, and performing stirring at a constant temperature to obtain a mixed solution; and
performing vacuum filtration on the mixed solution after the mixed solution is cooled to a room temperature, washing the mixed solution with ethanol, then drying the mixed solution in air at a room temperature after vacuum filtration, and obtaining the polyurethane microcapsule shell.

2. The preparation method according to claim 1, wherein the deionized water and the polyvinyl alcohol are mixed to obtain the aqueous phase A, and a mass ratio of the deionized water to the polyvinyl alcohol is 100 ml-150 ml:1 g-3 g.

3. The preparation method according to claim 2, wherein the deionized water and the polyvinyl alcohol are mixed to obtain the aqueous phase A, and a mixing temperature is 30 DEG C to 50 DEG C.

4. The preparation method according to claim 1, wherein the oil phase 4, 4′-methylenediphenyl diisocyanate is added into the aqueous phase A to obtain the emulsion, and a volume ratio of the aqueous phase A to the oil phase 4, 4′-methylenediphenyl diisocyanate is 15-18:1.

5. The preparation method according to claim 1, wherein the deionized water is mixed with the dibutyltin dilaurate and the ethylene glycol to obtain the aqueous phase B, and a volume ratio of the deionized water to the dibutyltin dilaurate to the ethylene glycol is 40-60:0.4-0.6:1.5-2.

6. The preparation method according to claim 1, wherein a molar ratio of the ethylene glycol to the 4, 4′-methylenediphenyl diisocyanate is 1:1.

7. The preparation method according to claim 1, wherein the emulsion is dropped into the aqueous phase B, stirring is performed at the constant temperature to obtain the mixed solution, and the constant temperature is 60 DEG C to 80 DEG C.

8. The preparation method according to claim 7, wherein duration of the stirring is 1.5 h to 2 h.

9. The preparation method according to claim 1, wherein the mixed solution is washed with the ethanol, and a mass fraction of the ethanol is 30%.

10. The preparation method according to claim 9, wherein a number of washing times is 2 to 3.
